(19) United States
(12) Patent Application Publication
(10) Pub. No.: US 2014/0121297 A1
(43) Pub. Date: May 1, 2014

(54) Solar Reflective Coating

(71) Applicant: Maximillian Medina Desphy, II, (US)

(72) Inventor: Maximillian Medina Desphy, Lake Elsinore, CA (US)

(73) Assignee: IMRAE CORPORATION, Lake Elsinore, CA (US)

(21) Appl. No.: 14/067,710

(22) Filed: Oct. 30, 2013

Related U.S. Application Data
(60) Provisional application No. 61/720,964, filed on Oct. 31, 2012.

(51) Int. Cl. C09D 5/33

(52) U.S. Cl. CPC C09D 5/004
USPC 523/135

(57) ABSTRACT

Presented are solar reflective coating compositions comprising a mixture of polymeric binder system of acrylic and alkyd dispersion. Also presented are various fillers and pigments of high infra-red (IR) reflecting property of large crystalline size containing aluminum dioxide, titanium dioxide, aluminum trihydrate and silicon dioxide particles.

### FIELD OF THE INVENTION

The invention is a coating material designed to reflect solar or near infrared rays from the sun. Particularly, the development of this product is designed to coat substrate materials in order to reduce the radiant heat absorbed due to the high emissivity of matte surface materials. More particularly, the coating material is designed to be applied on any type of concrete or cementitious surfaces due to its high emissivity level of between 0.85-0.95 (range 0.0-1.0 maximum), making it very ideal on absorbing radiant heat exposure. More particularly, the coating material is designed to be applied as an exterior coating to improve the cooling insulation of an exposed concrete or cementitious building material, such as roofs, walls, and other types of exposed concrete or cementitious surface materials, which is not limited to other concrete type of structures such as precast. Specifically, on building material used either for architectural (non-load bearing) or structural (load bearing) concrete design applications.

### BACKGROUND OF THE INVENTION

The building construction materials market has constantly evolved by incorporating various types of concrete and related cementitious products used in the fabrication of exterior building components. Concrete is a significant material used in various exterior building components, specifically in the fabrication of architectural (non-load bearing) and structural (load bearing) precast applications. The most common concrete precast used extensively for exterior building applications are poured concrete walls (load bearing), wall cladding (load & non-load bearing), roofing tiles (non-load bearing), and other architectural enhancements (non-load bearing), such as columns, cornices, and trims which adds definition into building designs.

Due to the popular use of these types of exterior precast materials, a growing challenge to architects, engineers, and green building designers persists in ensuring that building designs also contribute to the overall energy savings of a completed building. A major factor in energy savings is the infra red heat transmittance from sunlight that is easily absorbed by concrete, thus lowering its thermal efficiency in maintaining a consistent lower internal temperature, which can excessively force power demands on HVAC to generate more energy to maintain a controlled temperature. It is forecasted that energy demand and usage will continually increase in the next decades as urbanizations of cities continue and population increase. Various innovative ways of controlling or redirecting heat from UV sunlight rays have been developed in the past, mainly for roof coating applications applied on various types of building structures, such as bituminous asphalt shingles, concrete and clay tiles, and other cementitious roofing materials. In a disclosed U.S. Pat. No. 6,933,007, the use of reflective granules on a roofing material is claimed to produce an efficient energy roofing by raising the reflectivity; and another similar disclosed patent on U.S. Pat. No. 8,216,681, application of multi-layer polymeric product of various filled compositions improves the reflectivity. The modification of the polymer system either by increasing the pigmentation and/or the polymeric system are alternatives for improving reflectivity and performance characteristics due to physical degradation and wear overtime due to constant UV exposure affecting adhesion, abrasion resistance, and cracking. The immediate physical appearance such as color and texture, however, is immediately impacted as the natural surface look and feel of the material is altered and changed, such as in the use of IR (infra-red) filled paint. Likewise, incorporating large size particles or granules further deforms the surface of the material and would result to an undesirable and unqualified appearance.

In view of the existing state of arts, the precast industry cannot afford the use of these types of material, as aesthetic appearance are critical in ensuring acceptable design due to the required color and texture of the finished product. There is a specific need for a new innovative coating that is easy and simple to apply, and can maintain the natural appearance and required finish of the surface material, and provide a solar reflective characteristic desired for its intended application.

### BRIEF SUMMARY OF THE INVENTION

The present invention is a novel solar reflective coating formula that improves the performance characteristic of coated concrete or cementitious surfaces. This solar reflective coating formula raises the solar reflectivity of coated surfaces, and increases resistance to efflorescence, stain, abrasion, adhesion, and heat resistance characteristics.

The solar reflective coating is an opaque to white color base tintable to any various types of color variations, such as yellow, red, green, blue, brown, grey, and black. The solar reflective coating adheres very well to various porous and non-porous surfaces, particularly to concrete, modified cementitious surfaces, modified bitumen, wood, plastic, and steel. The solar reflectivity characteristic of the surface is determined by a solar reflectance meter that measures the solar reflectance. The solar reflectance is a measure of the ability of a surface material to reflect sunlight including the visible, infrared, and ultraviolet wavelengths on a scale of 0.01 to 1.00. A solar reflectance value of 0.0 indicates that the surface absorbs all solar radiation, and a 1.0 solar reflectance value represents complete 100% reflectivity. The current ENERGY STAR Reflective Roof Products criteria specify a solar reflectance of 0.65 or higher for low-slope roof applications and 0.25 for sloped roof.

This solar reflective coating invention is made up of a hybrid polymeric binder with additives and dispersed solid pigments. The binder composition is a mixture of an acrylic dispersion resin and modified with an alkyd dispersion resin, which includes additives such as, dispersants, UV stabilizers, thickener, defoamer, and biocides. The pigment composition is a mixture of various pigments and fillers with infra-red reflective properties and high brightness. The pigment to binder ratio is 1:9 or 10% pigment and 90% binder composed of 89% polymeric resins and 1% additives.

The solar reflective coating is a water based material that is applied either by brush, roller, or spray, and forms a dry film upon cure. The solar reflective coating contains low VOC or volatile organic compounds, which is below the current limits of AQMD (Air Quality Management District) Rule 1113 guideline for Architectural Coatings. Due to the low VOC characteristics of the coating, it can be applied either on interior or exterior areas of the building with little or no observed odor during its application. The performance characteristic of the product is immediately realized upon its normal cure, right after 24-hours of normal drying at 40-60% relative humidity and 60-80 deg. F. temperature conditions.

### DETAILED DESCRIPTION OF THE INVENTION

The invention described in this application is a novel solar reflective coating composition applied as a thin film coating. It provides enhanced performance characteristics on any applied substrate, such as concrete, wood, and/or other cementitious materials by raising the solar reflectivity of the coated surface of a horizontal, low sloped, and steep sloped roofing surfaces. The resulting increase in solar reflectivity of any coated surfaces subjected to sunlight exposure, such as roofings, building walls, and other types of enclosure shall benefit by reduction in energy consumption of structures equipped with HVAC in maintaining a cooler temperature. The solar reflectivity characteristic of the present invention has the ability to raise the solar reflectivity of an uncoated or unsealed concrete matte surface by 20% to even as high as 100% in different formula versions of color from dark to light in accordance to the CRRC (Cool Roof Rating Council) Method 1 in reference with ASTM (American Society for Testing and Materials Standard) C 1549 (Standard Test Method for Determination of Solar Reflectance Near Ambient Temperature Using a Portable Solar Reflectometer), which significantly affects the SRI value. The SRI (Solar Reflective Index) is a value that measures the combined solar reflectance and emittance readings in a single value to represent a material's temperature in the sun. SRI quantifies how hot a surface would get relative to standard black and standard white surfaces. It is calculated using equations based on previously measured values of solar reflectance and emittance. It is expressed as a fraction (0.0 to 1.0) or percentage (0% to 100%). The thermal emittance test is conducted in accordance with ASTM C1371-04a(2010)e1 (Standard Test Method for Determination of Emittance of Materials Near Room Temperature Using Portable Emissometers).

In addition, to having the aforementioned increase in solar reflectance values, the solar reflective coating of the present invention must exhibit other capabilities of maintaining required performance characteristics for concrete masonry, such as efflorescence resistance that is tested in accordance with ASTM C67-12 (Standard Test Methods for Sampling and Testing Brick and Structural Clay Tile) and in accordance to CRRC-1 section S.2.6 for aged testing by exposing to Hot/Humid climate, Cold/Temperature climate, and Hot/Dry climate conditions. The heating degree-day and cooling degree-day shall be tested in accordance to ANSI/ASHRAE Standard 169-2066. Particularly, testing performed on masonry concrete materials on specimen mounting exposure for both metallic and non-metallic materials shall be performed in accordance with ASTM G7/G7M-11 (Standard Practice for Atmospheric Environmental Exposure Testing of Nonmetallic Materials). Moreover, the performance characteristics of the Solar Reflective Coating have to maintain a solar reflectance value consistently for a minimum of three years after initial installation and measurement under normal conditions. This measurement can be performed by conducting a test in accordance with ASTM C 1549 (Standard Test Method for Determination of Solar Reflectance Near Ambient Temperature Using a Portable Solar Reflectometer), which is applicable to both low-sloped or steep-sloped roofing applications.

The solar reflective coating composition of the present invention is made up of two major components, the binders (resins) and pigments including additives, which improves the characteristics of the formulation in the present invention.

The first major component, the binder resins, is composed of thermoplastic water dispersion resin, particularly of low Tg (glass transtition tempertature) resins with a range from −25 to 25° C. (Centigrade), specifically an acrylic ester copolymer is used as the main binder for this present invention. However, other thermoplastic polymers or copolymers, such as Acrylics, Styrene Acrylics, Vinyl Acrylics emulsions or disperion resin systems can also be used as the main binder. Other water based acrylic-hybrids, such as acrylic-urethane and acrylic-epoxy resin systems capable of forming a film onto surface can also be used as binders.

The amount of the acrylic ester dispersion resin in the present invention can vary from 15 up to 30% pbw (parts by weight) based on 100% by weight of the total mixture, depending on the total solid contents of the resin system. The preferred amount is about 23-26% pbw acrylic ester dispersion based on 50% non-volatile or solids content of the binder resin.

To improve the film characteristics of the main binder resin, a co-binder resin is used to modify the properties of the main acrylic ester resin to enhance its early water and humidity resistance. As a result, the performance characteristics of the film is further improved by increasing resistance against corrosion, chemicals, and other solvents.

The co-binder resin is based on an alkyd dispersion systems and diluted in propoxy propanol solvent as its main carrier. However, other dispersion resins, such as urethane and epoxy dispersions can also be used to further improve its film performance characteristics against attacks from corrosion, chemicals and other solvents.

The amount of the co-binder alkyd dispersions resin in the present invention can vary from 8 up to 15% pbw (parts by weight) based on 100% weight of the total mixture, depending on the total solid contents of the resin system. The preferred amount is about 10-13% pbw alkyd dispersion based on 70% non-volatile or solids content of the co-binder resin.

The addition of the co-binder alkyd dispersion resin in the present invention requires the addition of a dispersant to aid in the dispersion of the alkyd resin in the solution. A Tri-Ethanol Amine (TEA) is premixed in water prior into the addition of the alkyd dispersion. The required amount can vary from 1-2% pbw based on 100% by weight of the total mixture. The preferred amount is based on 1.5% pbw of TEA based on 15-18% pbw of the alkyd dispersion on 100% by weight of the total mixture.

The binder system of the present invention only contains water as its solvent, but other coalescing solvents can also be used to improve the freeze-thaw stability of the film, such as ester alcohol or glycol solvents. It is added based on 2.5% of the main binder resin solids only, and can be any of the following, Texanol (2,2,4-Trimethyl-1,3-pentanediol Monoisobutyrate), and/or mid to fast Dowanol solvents, such as PMA glycol ether, DPM glycol ether, DPMA glycol ether. The choice and use in combination of other coalescing solvents mentioned above in the present invention are dependent in the cure times desired, and are well known to those skilled in the art of formulation.

The binder system of the present invention can also be thickened by using HEUR type (Hydrophobically modified Ethoxylated Urethane) thickener systems for non-ionic to anionic water based resin systems. The stability and immediate reactivity of the thickener improves the rheology of the binder system and its compatibility with all the combined binder resins. A linear chain HEUR polymer is considered as a low (MW) molecular weight thickener, whereas a highly branched HEUR chain polymer is considered a high (MW) molecular weight thickener containing a higher amount of hydrophobe linkages in the polymer chain.

The amount of the HEUR thickener in the present invention can vary from 0.30 up to 1.00% pbw (parts by weight) based on 100% by weight of the total mixture, depending on the molecular weight (dependent on the amount of hydrophobes) of the HEUR thickener system used. The preferred amount is about 0.3-0.35% pbw based on a high molecular weight (higher amount of hydrophobes) HEUR thickener system with an optimum viscosity efficiency observed at a minimum pH of 8 in the binder system.

The efficiency of the HEUR thickener is improved by using a high MW thickener, particularly the addition of dispersed colorants that contains undetermined amount and various types of surfactant in proportion to the amount of colorants needed to match a specific color. This can significantly affect the viscosity of the final formulation. To address this concern, use of high MW HEUR thickeners helps to mitigate this problem and consistent viscosity is immediately established without considerably increasing the amount of thickener in the formula.

The binder system and the selected thickener (i.e. HEUR) of the present invention requires the use of a specific class of polysiloxane defoamers to ensure compatibility during mixing and post additions with the binder system, while ensuring excellent defoaming efficiency. A critical factor in the present invention is the discovered compatibility of the TEA dispersant, HEUR thickener, and the PolySiloxane defoamer are found to improve the rheology of the binder system.

The second major component of the present invention is the pigmentation system, a mixture of fillers to improve other critical performance characteristics, such as abrasion resistance, hardness, refractive index, and brightness. Most importantly, the pigment color dispersions significantly affects the solar reflectivity of the coating.

The filler system of the present invention is composed of nano size particles of silicon dioxide from 0.7mm to 2 um. The amount added in the present invention can vary from about 0-50% by weight of the total pigmentation system. Depending on the total pbw content of the colored pigment required to match the color at 1:9 pigment to binder ratio, the weight could vary in the total formulation. Moreover, other fillers such as aluminum oxide, calcium carbonate, and aluminum trihydride (ATH) can be used in the invention.

The white pigment of the color dispersion of the present invention is composed of aluminum pigment with a particle size distribution ranging from 20-78 um, and titanium dioxide with a minimum desired purity of 93%. The two pigments are either used by itself at 100% or in 50/50 combination, and added at about 20-100% by weight of the total pigmentation system. Depending on the total pbw content of the colored pigment required to match the color at 1:9 pigment to binder ratio, the weight could vary in the total formulation.

The color pigments that are used to tint the solar reflective coating of the present invention are the common yellow iron oxide, red iron oxide, cobalt blue, and a select IR (infra-red reflective) pigments of green and black. A nano size particle of tin dispersion can also be used as a black pigment colorant in tinting dark shades of color.

The addition of other fillers and/or additives in the solar reflective coating of the present invention can further improve other performance characteristics, by increasing or replacing other fillers or pigments, and optimizing the amounts that are well known to those skilled in the art. For increased abrasion resistance, the addition of aluminum oxide dispersions; for improved fire retardancy, the addition of zinc borate and alkali metal silicates; for increased UV stability, light stabilizers such as hindered amines; for controlling bacteria, biocides; for maintaining alkalinity to stabilize the emulsion, aqueous ammonia can all promote stability in the present invention. The amounts and compatibility of other fillers and additives to the previously selected materials, such as TEA, HEUR thickener, and Poly Siloxane defoamer in the binder system are critical in this present invention. The issue of compatibility and in determining the performance characteristics of the final formulation, such as the cleanliness and stability of the mixed material are important and are known to those skilled in the art.

The manufacturing or mixing process of the present invention requires the use of an appropriate mixing tank that is 1.2 times the actual volume size of the batch, and a disperser capable of running at both low and high speeds, which should be capable of operating at 100-500 rpm (revolutions per minute) for low speed and 1,000-3,000 rpm for high speed mixing. To those skilled in the art of mixing, an ideal mixing condition requires a donut shape appearance to be exhibited to ensure consistent mixing of all the components.

The initial mixing process requires the addition of water at 30-35% pbw based on 100% by weight of the total mixture, and mixed at low speed, and then immediately followed by the addition of biocide, TEA, and Defoamer. The mixing is continued for 10 minutes and then followed by the addition of the alkyd-dispersion resin, and continuously mixed for 15 minutes at high speed. At this point, the initial appearance of thick cloudy yellowish white color immediately occurring upon contact with water should slowly begin to change and transform to a homogenous clear to light-amber color with consistent homogenous appearance.

The addition of fillers and white pigments are then added at this stage and continuous mixing at high speed resumes. To those skilled in the art, completion of high speed mixing is achieved only when the Hegman grind of 7+ of the mixture is finally achieved. Once completed, the letdown mixing process begins by lowering the speed while adding the entire acrylic ester resin and simultaneously followed with the addition of the entire defoamer and thickener required in the formula. The mixing continues by adjusting the speed gradually from low to medium blending speed until a donut appearance effect is observed. Once all the material has been added, the mixing process is continued for the next 15 minutes to ensure that all materials are consistently mixed and a homogenous appearance is achieved. At this point, colorant dispersions can now be added to match the desired color, and once achieved the final pH and viscosity is checked and adjusted to its respective specifications.

The resulting mixed product of the present invention is classified as a complete product claimed as a solar reflective coating, which can be applied to various substrates of many roofing products, from galvanized steel, bituminous and modified bituminous based materials, clay, concrete precasts, and other cementitious modified materials. This solar reflective coating can be applied either by brush, roll, spray or dipping techniques, very similar to any other type of liquid or sealer type coatings. This solar reflective coating cures or dry within 15 minutes with a tack free time of 5 minutes, dry-to-touch from 10-15 minutes, and dry-hard condition in about 3-6 hours depending on the thickness of the coating, and the ambient temperature condition during its application.

The unique property of the present invention exhibits the desired characteristics of a typical fast-cure coating for quick installation and recoating properties in the field during post applications. It also very suitable for use in high speed product or building material manufacturing processes that requires fast set-up times. As a result, building manufacturers can efficiently ship a better product to the customer with more value due to its increase solar reflectivity, which by industry standards is soon to be required on many roof building material specifications.

The table below is an example of a solar reflective coating composition as described in the present invention, which provides the performance characteristics as described above when applied on various substrates. Specifically, the composition is a base range of fillers and pigments that is formulated to match any color designed to raise the solar reflectance value of a coated substrate.

TABLE-US-00001 Formulation of the present invention. Raw Material Description and percent by weight of total mixture, Acrylic Ester (BASF, Rohm & Haas) 15-30%, Alkyd Dispersion (Reichold Resins) 8-15%, Tri-Ethanol Amine (Dow Chemicals) 1-2%; HEUR (Rohm & Haas) 0.30-1.0%; PolySiloxane (BYK-Gardner) 0.25-0.50%; Silicon Dioxide (Cristobalite) 5-20%; Aluminum Pigment (Eckart Pigments)5-20%; Titanium Dioxide (Huntsman Chemicals) 0-14%; Water 35-65%; IR Black Pigment (NovoColor) 5-20%; Yellow Oxide (NovoColor) 5-20%; Red Oxide (NovoColor) 5-20%; Green (NovoColor) 5-20%

The addition of other fillers and additives are optional as discussed above that can enhance other performance characteristics of the present invention in the amounts that are well known to those skilled in the art of formulation. The following tables below are solar reflective coating formulations of specific base colors using specific pigments, which can be used for cross tinting to match various colors.

TABLE-US-00002 Formulation of the present invention. Raw Material Description and percent by weight of total mixture, Acrylic Ester 15-30%, Alkyd Dispersion 8-15%, TEA (Tri-Ethanol Amine) 1-2%; HEUR (Thickener) 0.30-1.0%; PolySiloxane (Defoamer) 0.25-0.50%; Silicon Dioxide 5-20%; Aluminum Pigment 5-20%; Titanium Dioxide 0-14%; Water 35-65%

TABLE-US-00003 Formulation of the present invention. Raw Material Description and percent by weight of total mixture, Acrylic Ester 15-30%, Alkyd Dispersion 8-15%, TEA (Tri-Ethanol Amine) 1-2%; HEUR (Thickener) 0.30-1.0%; PolySiloxane (Defoamer) 0.25-0.50%; Silicon Dioxide 5-20%; Aluminum Pigment 5-20%; Water 35-65%; IR Black Pigment 5-20 TABLE-US-00004 Formulation of the present invention. Raw Material Description and percent by weight of total mixture, Acrylic Ester 15-30%, Alkyd Dispersion 8-15%, TEA (Tri-Ethanol Amine) 1-2%; HEUR (Thickener) 0.30-1.0%; PolySiloxane (Defoamer) 0.25-0.50%; Silicon Dioxide 5-20%; Aluminum Pigment 5-20%; Water 35-65%; Yellow Oxide 5-20%

TABLE-US-00005 Formulation of the present invention. Raw Material Description and percent by weight of total mixture, Acrylic Ester 15-30%, Alkyd Dispersion 8-15%, TEA (Tri-Ethanol Amine) 1-2%; HEUR (Thickener) 0.30-1.0%; PolySiloxane (Defoamer) 0.25-0.50%; Silicon Dioxide 5-20%; Aluminum Pigment 5-20%; Water 35-65%; Red Oxide 5-20%

TABLE-US-00006 Formulation of the present invention. Raw Material Description and percent by weight of total mixture, Acrylic Ester 15-30%, Alkyd Dispersion 8-15%, TEA (Tri-Ethanol Amine) 1-2%; HEUR (Thickener) 0.30-1.0%; PolySiloxane (Defoamer) 0.25-0.50%; Silicon Dioxide 5-20%; Aluminum Pigment 5-20%; Water 35-65%; Green 5-20%

The solar reflective coating formulation of the present invention can be applied in its fluid form without the need for any other adjustments, unless for specific application that could either require increased or decreased viscosity. Since the product can be applied by brush, dip, roll, or spray using various spray systems, such as convention air guns or air assisted equipment HVLP (High Volume Low Pressures) sprayers. The application thickness is dependent on the desired reflectance value and can be increased incrementally by the number of coats applied on the surface of the color matched.

It will thus be seen that the formulation of the present invention shown above, and among those shown are accurately depicted, and since certain changes to the final formulation can be made by those skilled in the art, it will be understood that the foregoing and other changes in forms and details may be made without departing from the spirit and scope of the invention, it is intended that all matter contained in the above formulation and shown in the following tables shall be interpreted as illustrative and limiting in sense. Modifications and changes will become apparent to those skilled in the art upon reviewing and understanding the purpose of each raw material provided herein. This invention is intended to include all formula modifications as they come within the scope of the present invention. It is also to be understood that the following claims are intended to cover all of the generic raw materials and its specific features and purpose of the present invention described, and all the statements, which is a matter of language and might be said to fall there between.

We claim:

1. A solar reflective coating composition comprising: (a) a polymeric binder system of thermoplastic water dispersion resin and an acrylic ester copolymer dispersion in an amount ranging from 23-45 percent by weight, based on the total weight of the solar reflective coating composition; (b) an anionic dispersant and pH modifier additive, in an amount ranging from 1-2 percent by total weight that is added into water prior to the addition of the dispersion resin; (c) a thickener additive, in an amount of 0.03-1.00 percent by total weight that is added to improve the rheology and viscosity of the solar reflective coating; (d) a defoamer additive, in an amount of 0.25-0.50 percent by total weight that is added to aid in the release of entrapped air; (e) a filler extender, in an amount of 5.00-20 percent by total weight that is added to increase infra-red (IR) reflective properties; (f) an aluminum pigment, in an amount of 5-20 percent by total weight that is added to increase infra-red (IR) reflective properties; (g) a titanium dioxide with a minimum purity of 93% in an amount, that is added to increase infra-red (IR) reflective property of the solar reflective coating composition.

2. The solar reflective coating of claim 1 wherein the polymeric binder (a) comprises an alkyd water dispersible, chain stopped alkyd with a 69-71 percent solids by weight and (b) acrylic ester dispersion with a 50 percent solids by weight.

3. The polymer binder of claim 2 consisting of an alkyd dispersion (a) is further consist of water as solvent and traces of diluted propoxy propanol, butoxy ethanol, and secondary butanol.

4. The polymer binder of claim 2 consisting of an acryic ester dispersion (b) has a glass transition temperature ranging from 5-20 degrees centigrade.

5. The solar reflective coating of claim 1 wherein the anionic dispersant additive (b) comprises a weak base of tri-ethanol amine (TEA).

6. The anionic dispersant of claim 5 is added in the range of 1-2 percent by weight based on the amount of alkyd dispersion ranging from 15-18 percent by total weight of the coating.

7. The solar reflective coating of claim 1 wherein the thickener additive (c) comprises a hydrophobically modified ethoxylated thickener (HEUR).

8. The solar reflective coating of claim 1 wherein a defoamer additive (d) comprises a ethoxylated polysiloxane emulsion system.

9. The solar reflective coating of claim 1 wherein the filler extender added (e) comprises silicon dioxide and/or aluminum oxide, calcium carbonate, aluminum trihydrate and mixture thereof.

10. The solar reflective coating of claim 1 wherein the aluminum pigment (f) comprises aluminum pigment and titantium dioxide mixture of particle size ranging from 20-78 μm.

11. The solar reflective coating of claim 1 wherein that titanium dioxide (g) comprises a minimum of 99 percent rutile crystal titanium dioxide, and traces of aluminum oxide at 1-3 percent and silicon dioxide at 2-4 percent.

12. The solar reflective coating is tintable with various types of oxide pigments.

13. The solar reflective coating is applied as a single reflective layer.
